(19) United States
(12) Patent Application Publication
(10) Pub. No.: US 2025/0068451 A1
(43) Pub. Date: Feb. 27, 2025

(54) VIRTUAL RESOURCE ACQUISITION METHOD AND APPARATUS, DEVICE, AND STORAGE MEDIUM

(71) Applicant: Beijing Zitiao Network Technology Co., Ltd., Haidian District, Beijing (CN)

(72) Inventors: Yiying WU, Beijing (CN); Yaping LI, Beijing (CN)

(21) Appl. No.: 18/726,765

(22) PCT Filed: Jan. 9, 2023
(86) PCT No.: PCT/CN2023/071237

§ 371 Date: Jul. 3, 2024

(30) Foreign Application Priority Data
Jan. 20, 2022 (CN) 202210068404.9

(51) Int. Cl. G06F 9/455

(52) U.S. Cl. CPC G06F 9/45558; G06F 2009/45583

(57) ABSTRACT

The present disclosure provides a method of obtaining a virtual resource, an apparatus, an electronic device, a storage medium, a computer program product, and a computer program. The method includes: displaying a first capturing interface in response to a first instruction triggered by a user, the first capturing interface including a plurality of target capturing modes; and in response to a triggering operation of the user on the first capturing interface, obtaining a first virtual resource, and displaying an icon corresponding to the first virtual resource on the first capturing interface, where the plurality of the target capturing modes include at least one variable capturing mode.

### CROSS-REFERENCE TO RELATED APPLICATION

The present disclosure claims the priority to Chinese Patent Application No. 202210068404.9 with the title of “VIRTUAL RESOURCE ACQUISITION METHOD AND APPARATUS, DEVICE, AND STORAGE MEDIUM” filed on Jan. 20, 2022, the entire disclosure of which is incorporated herein by reference as part of the disclosure of this application.

### TECHNICAL FIELD

The present disclosure relates to the field of information interaction technology, in particular to a method of obtaining a virtual resource, an apparatus, an electronic device, a storage medium, a computer program product, and a computer program.

### BACKGROUND

With the development of network technology, applications, such as instant messaging and video applications, are penetrating into every aspect of life of people and become an indispensable part of life of people, thus providing a necessary platform for the implementation of various online activities. Therefore, in order to improve the user experience of applications, it is necessary to enrich the interaction methods of applications. In particular, these applications may usually interact with cameras in operation, however, the supported functions of the cameras in the prior art are relatively single, and the interaction invocation method is cumbersome, resulting in less than ideal interaction with users and other applications, so that the utilization rate of the cameras is also relatively low.

### SUMMARY

The present disclosure provides a method of obtaining a virtual resource, an apparatus, an electronic device, a storage medium, a computer program product, and a computer program, which are used for solving the technical problem that the interaction form between the camera and the user as well as other applications is relatively single due to the insufficient function and flexibility of the camera in the prior art.

In a first aspect, the embodiments of the present disclosure provide a method of obtaining a virtual resource, comprising:

displaying a first capturing interface in response to a first instruction triggered by a user, where the first capturing interface comprises a plurality of target capturing modes; and

in response to a triggering operation of the user on the first capturing interface, obtaining a first virtual resource, and displaying an icon corresponding to the first virtual resource on the first capturing interface,

where the plurality of the target capturing modes comprise at least one variable capturing mode, and the variable capturing mode is configured to change with time.

In a second aspect, the embodiments of the present disclosure further provide a virtual resource obtaining apparatus, comprising:

a triggering module, configured to display a first capturing interface in response to a first instruction triggered by a user, wherein the first capturing interface comprises a plurality of target capturing modes; and

an acquisition module, configured to, in response to a triggering operation of the user on the first capturing interface, obtain a first virtual resource, and display an icon corresponding to the first virtual resource on the first capturing interface, wherein the plurality of the target capturing modes comprise at least one variable capturing mode, and the variable capturing mode is configured to change with time.

In a third aspect, the embodiments of the present disclosure further provide an electronic device, comprising:

a processor; and

a memory, configured to store a computer program,

where the processor is configured to implement the method of obtaining the virtual resource according to the first aspect and various possible designs of the first aspect described above by executing the computer program.

In a fourth aspect, the embodiments of the present disclosure further provide a computer-readable storage medium, the computer-readable storage medium stores computer-executable instructions, and the computer-executable instructions, when executed by a processor, cause the processor to implement the method of obtaining the virtual resource according to the first aspect and various possible designs of the first aspect described above.

In a fifth aspect, the embodiments of the present disclosure further provide a computer program product, the computer program product comprises a computer program, and the computer program, when executed by a processor, causes the processor to implement the method of obtaining the virtual resource according to the first aspect and various possible designs of the first aspect described above.

In a sixth aspect, the embodiments of the present disclosure further provide a computer program, and the computer program, when executed by a processor, causes the processor to implement the method of obtaining the virtual resource according to the first aspect and various possible designs of the first aspect described above.

### BRIEF DESCRIPTION OF DRAWINGS

In order to more clearly illustrate the technical solutions of the embodiments of the present disclosure or technical solutions in the prior art, the drawings that need to be used in description of the embodiments or prior art will be briefly introduced in the following. It is obvious that the drawings described below are only related to some embodiments of the present disclosure, and for those skilled in the art, other drawings can be obtained based on these accompanying drawings without inventive efforts.

FIG. 1 is a flowchart of a method of obtaining a virtual resource provided by an embodiment of the present disclosure;

FIG. 2 is a schematic diagram of a second capturing interface provided by an embodiment of the present disclosure;

FIG. 3 is a schematic diagram of a virtual resource display interface provided by an embodiment of the present disclosure;

FIG. 4 is a schematic diagram of a first capturing interface provided by an embodiment of the present disclosure;

FIG. 5 is a schematic diagram of a first capturing mode provided by an embodiment of the present disclosure;

FIG. 6 is a schematic diagram of another first capturing mode provided by an embodiment of the present disclosure;

FIG. 7 is a schematic diagram of an image capturing completion interface provided by an embodiment of the present disclosure;

FIG. 8 is a schematic diagram of a virtual resource acquisition interface provided by an embodiment of the present disclosure;

FIG. 9 is a schematic diagram of a third capturing mode provided by an embodiment of the present disclosure;

FIG. 10 is a schematic diagram of another third capturing mode provided by an embodiment of the present disclosure;

FIG. 11 is a schematic diagram of still another third capturing mode provided by an embodiment of the present disclosure;

FIG. 12 is a flowchart of another method of obtaining a virtual resource provided by an embodiment of the present disclosure;

FIG. 13 is a schematic diagram of an interface switching provided by an embodiment of the present disclosure;

FIG. 14 is a schematic diagram of another interface switching provided by an embodiment of the present disclosure;

FIG. 15 is a flowchart of still another method of obtaining a virtual resource provided by an embodiment of the present disclosure;

FIG. 16 is a schematic structural diagram of a virtual resource obtaining apparatus provided by an embodiment of the present disclosure; and

FIG. 17 is a schematic structural diagram of an electronic device provided by an embodiment of the present disclosure.

### DETAILED DESCRIPTION

The embodiments of the present disclosure will be described in more detail below with reference to the accompanying drawings. While certain embodiments of the present disclosure are shown in the drawings, it should be understood that the present disclosure may be embodied in various forms and should not be construed as limited to the embodiments set forth herein. Rather, these embodiments are provided for a thorough and complete understanding of the present disclosure. It should be understood that the drawings and embodiments of the present disclosure are only for exemplary purposes and are not intended to limit the protection scope of the present disclosure.

It should be understood that the various steps described in the method implementations of the present disclosure may be performed in different orders and/or in parallel. Furthermore, the method implementations may include additional steps and/or omit performing the illustrated steps. The scope of the present disclosure is not limited in this aspect.

As used herein, the terms “include,” “comprise,” and variations thereof are open-ended inclusions, i.e., “including but not limited to.” The term “based on” is “based, at least in part, on.” The term “an embodiment” represents “at least one embodiment,” the term “another embodiment” represents “at least one additional embodiment,” and the term “some embodiments” represents “at least some embodiments.” Relevant definitions of other terms will be given in the description below.

It should be noted that the modifications of “a,” “an,” “a plurality of,” and the like mentioned in the present disclosure are illustrative rather than restrictive, and those skilled in the art should understand that unless the context clearly indicates otherwise, these modifications should be understood as “one or more.”

In the related art, a collection activity of virtual resources may be implemented by various applications, so as to enable the user to collect virtual resources after completing a preset operation. However, in the existing process of acquiring the virtual resource, the method of interacting with the user is relatively single, and the experience of the user is poor. In particular, these applications may usually interact with the camera in operation, however, the supported functions of the camera in the prior art are relatively single, and the interaction invocation method is cumbersome, resulting in less than ideal interaction of the camera with the user and other applications, so that the utilization rate of the camera is also relatively low.

Regarding the above technical problems, the present disclosure is intended to: provide a plurality of target capturing modes on a capturing interface corresponding to the virtual resource, and obtain the virtual resource after completing corresponding triggering operations for different target capturing modes. Furthermore, the target capturing modes also include at least one variable capturing mode, which changes with time. In this way, the first virtual resource is obtained by using multiple target capturing modes, and the target capturing modes can also vary with time, thereby increasing the functions and flexibility of the camera, and enriching the form of interaction with the user and other applications. Also the interaction invocation method for the camera is relatively simple, and the provided functions and interaction performance can be expanded without increasing the difficulty of operation, thus improving the user experience. It can be understood that the variable capturing mode involved in the present disclosure may be a capturing mode in which a certain element (e.g., a virtual object such as a virtual prop) on the capturing interface changes with time.

In the following, an application scenario of a method of obtaining a virtual resource provided by the present disclosure is described.

In an application scenario of the method of obtaining the virtual resource, the method of obtaining the virtual resource provided by the embodiment may be applied in a scenario of a video application. When using the video application, the user may open the capturing interface corresponding to the virtual resource activity, and select different target capturing modes on the capturing interface to complete the triggering operation corresponding to the target capturing mode, thereby obtaining the virtual resource.

In another application scenario of the method of obtaining the virtual resource, the method of obtaining the virtual resource provided by the embodiment may also be applied in a scenario of an instant messaging application. When using the instant messaging application, the user may jump to the capturing interface corresponding to the virtual resource activity by clicking on a control of the virtual resource activity interface, and the virtual resource can be obtained by performing image capturing or posting on the capturing interface. In addition, the user may also exchange the virtual resource with others through the instant messaging application.

It should be noted that the above two application scenarios do not constitute a limitation to the present disclosure, and the method of obtaining the virtual resource provided by the present disclosure can be applied to any scenario of obtaining the virtual resource.

It can be understood that the above-described method of obtaining the virtual resource may be achieved by the virtual resource obtaining apparatus provided by the embodiments of the present disclosure, and the virtual resource obtaining apparatus may be a part or all of a device, for example, a terminal device or a processor of the terminal device.

The technical solutions of the embodiments of the present disclosure are described in detail through the specific embodiments below. These following specific embodiments may be combined with each other, and the same or similar concepts or processes may not be repeated in some embodiments.

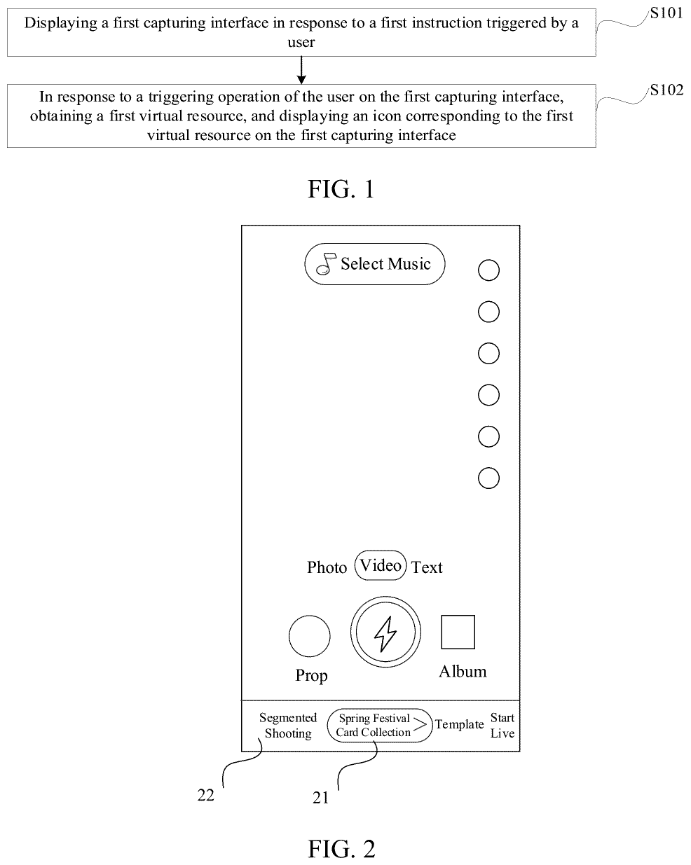

FIG. 1 is a flowchart of a method of obtaining a virtual resource provided by an embodiment of the present disclosure. As shown in FIG. 1, the method of obtaining the virtual resource provided by the present embodiment includes:

Step 101: displaying a first capturing interface in response to a first instruction triggered by a user, the first capturing interface including a plurality of target capturing modes.

Here the first instruction is used to instruct switching the different interface of the application to the first capturing interface.

It should be understood that the embodiments of the present disclosure do not impose the limitation on the first capturing interface, which may be an existing capturing interface of the application or may also be a capturing interface exclusive to the virtual resource collecting activity.

It should be understood that the embodiments of the present disclosure do not restrict the type of the virtual resource, which may be a card resource, an emoji packet resource, a virtual gold coin resource, etc.

It should be noted that how to trigger the first instruction is also not limited in the embodiments of the present disclosure, and three possible methods for triggering the first instruction are provided in the following, that is, three entrances to the first capturing interface.

In the first method, the first instruction may be triggered by the first control on the second capturing interface of the application. Here the second capturing interface may be the original capturing interface of the application for picture or video capturing, and the first control may be set at a fixed position on the second capturing interface, or may be covered on a capturing button of the second capturing interface.

For example, in the case of the video application, in response to the third instruction triggered by the user on the video playing interface, the terminal device may switch the video playing interface to the second capturing interface, the second capturing interface is provided with the first control corresponding to the first instruction, and the first instruction is configured to switch the second capturing interface to the first capturing interface. Subsequently, the user may trigger the first instruction by clicking on the first control, and in response to the first instruction, the terminal device may switch the second capturing interface to the first capturing interface for display.

Optionally, the first control on the second capturing interface may be hidden. The user may trigger the fourth instruction by sliding the second target region of the second capturing interface, and in response to the fourth instruction, the terminal device may hide the first control.

It should be understood that the embodiments of the present disclosure do not restrict the location of the second target region, and the second target region may be the region where the first control is located, the top half region of the second capturing interface, or the bottom half region of the second capturing interface.

FIG. 2 is a schematic diagram of a second capturing interface provided by an embodiment of the present disclosure. As shown in FIG. 2, in the second capturing interface, the first control 21 corresponding to the virtual resource collecting activity is provided below the capturing button. By clicking on the first control 21, the first instruction can be triggered to display the first capturing interface. In addition, the region where the control below the capturing button is located may be the second target region 22, and the first control 21 may be hidden by performing the sliding operation to the left or to the right in the second target region 22.

In the second method, the first instruction may be triggered through the second control on the virtual resource display interface, and accordingly, in response to the first instruction triggered by the user by clicking on the second control on the virtual resource display interface, the terminal device may switch the virtual resource display interface to the first capturing interface for display.

Here the above-described virtual resource display interface includes at least one of the following information: the virtual resource that has been acquired by the user, the collection time of the virtual resource, or the target capturing mode corresponding to the virtual resource.

In some embodiments, the second controls correspond to different target capturing modes, and after the user clicks on the second controls corresponding to different target capturing modes, the terminal device may not only display the first capturing interface, but also switch the target capturing mode to a target capturing mode corresponding to the second control for triggering the first instruction on the first capturing interface.

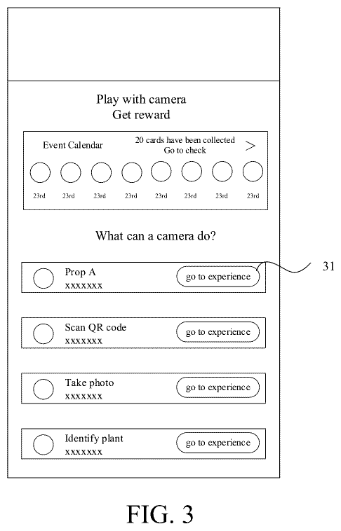

For example, FIG. 3 is a schematic diagram of a virtual resource display interface provided by an embodiment of the present disclosure. As shown in FIG. 3, the virtual resource display interface includes two regions, an activity calendar is included in the first region for recording the collection time of the virtual resource, and the second region includes different target capturing modes corresponding to the virtual resource activity, such as “Prop A,” “Scan QR code,” “Photograph,” “Identify plant,” or other capturing modes. The second control 31 is set after each target capturing mode. When the second control corresponding to the “Identify plant” capturing mode is clicked, the terminal device may not only switch to display the first capturing interface, but also switch to the “Identify plant” capturing mode on the first capturing interface.

In the third method, the first instruction may be triggered by the third control on the user information interface. Accordingly, in response to the first instruction triggered by the user by clicking on the third control on the user information interface, the terminal device may switch the user information interface to the first capturing interface for display.

In the embodiments of the present disclosure, a plurality of target capturing modes may include at least one variable capturing mode, and the variable capturing mode is configured to change with time. It should be understood that the variable capturing mode may be a capturing mode in which at least one element on the first capturing interface changes with time.

It should be noted that the embodiments of the present disclosure do not impose the limitation on the element that changes with time, and for example, the element may be a virtual object on the first capturing interface.

In some embodiments, after displaying the first capturing interface, the terminal device may also switch to different target capturing modes on the first capturing interface in response to the second instruction triggered by the user. Here the triggering method of the second instruction includes sliding in a preset direction of the first capturing interface.

It should be understood that the embodiments of the present disclosure do not impose any restriction on the preset direction, and in some embodiments, the preset direction may be to the left or may also be to the right.

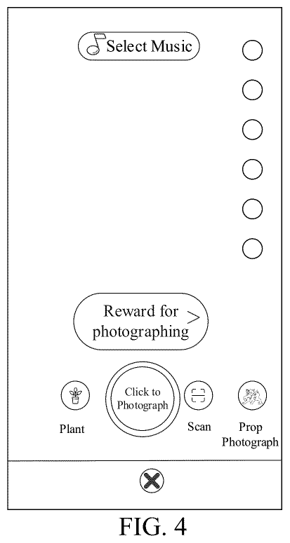

FIG. 4 is a schematic diagram of a first capturing interface provided by an embodiment of the present disclosure. As shown in FIG. 4, the first capturing interface is provided with capturing controls corresponding to a plurality of the target capturing modes, such as “Prop A,” “Scan QR code,” “Photograph,” “Identify plant,” or other capturing modes. The user can switch between different target capturing modes by sliding to the left or to the right on the first capturing interface. In the first capturing interface, prompt information may also be displayed to indicate that the user may obtain the virtual resource by image capturing or posting.

In some embodiments, when the first entry into the first capturing interface is detected, the terminal device may directly display an acquisition control for the virtual resource on the first capturing interface, and after the user clicks on the acquisition control, the virtual resource may be directly acquired, and the acquired virtual resource may be displayed.

It should be understood that the embodiments of the present disclosure do not limit the types of the target capturing modes, and in some embodiments, the target capturing modes may include the first capturing mode, the second capturing mode, and the third capturing mode.

Here the first capturing mode is configured to add the virtual object to the captured image, and the first capturing mode may be the variable capturing mode described above. In the first capturing mode, the virtual object is updated according to the preset time period. Exemplarily, the arranged order of the virtual objects is updated according to the preset time period.

It should be understood that the embodiments of the present disclosure do not impose the limitation on the type of the above-described virtual object, and exemplarily, the virtual object may be a virtual reality (VR) prop, a sticker prop, etc.

It should be understood that the embodiments of the present disclosure also do not impose the limitation on the background of the image to which the virtual object is added. In some embodiments, the background may be a pre-generated background sticker; and in other embodiments, the background may also be a picture that is actually captured by the camera.

In some embodiments, when it is switched to the first capturing mode, the terminal device may acquire the preset number of virtual objects from the virtual object pool according to the arranged order of the virtual objects. Subsequently, the terminal device may display at least one virtual object among the preset number of virtual objects in the first target region on the first capturing interface.

Exemplarily, when there are 40 virtual objects arranged in order in the virtual object pool, the terminal device may acquire the first five virtual objects in the virtual object pool every day. Subsequently, two of the virtual objects may be displayed in the first target region on the first capturing interface in the first capturing mode. When the user performs a sliding operation in the first target region, the virtual objects displayed in the first target region may be switched so as to display the remaining three virtual objects.

In some embodiments, the arranged order of the virtual objects is determined based on associated information of the virtual objects, and the associated information of the virtual objects includes historical usage information of the virtual objects and/or historical usage information of the user.

Exemplarily, the arranged order of the virtual objects is “virtual object A, virtual object B, virtual object C, . . . , virtual object Z.” When the user has acquired the virtual object A or after the number of total acquisition times of the virtual object A exceeds the threshold value, the virtual object A may be arranged in the last position, thereby updating the arranged order of the virtual objects to “virtual object B, virtual object C, virtual object D, . . . , virtual object Z, virtual object A.”

It should be understood that the embodiments of the present disclosure do not limit the update period of the arranged order of the virtual objects. Exemplarily, the arranged order of the virtual objects may be updated once per natural day.

Here the second capturing mode is configured to capture images.

Here the third capturing mode is configured to identify the captured object to be identified.

It should be understood that the embodiments of the present disclosure are also not limited in the type of the object to be identified. In some embodiments, the object to be identified may be a preset type of object, such as a plant, an animal, etc.; and in other embodiments, the object to be identified may be the information code, such as the QR code, information code, bar code, etc. The above information code may include user information for performing operations such as friend addition.

Step 102: in response to a triggering operation of the user on the first capturing interface, obtaining a first virtual resource, and displaying an icon corresponding to the first virtual resource on the first capturing interface.

In Step 102, after the terminal device displays the first capturing interface, the user may select different target capturing modes on the first capturing interface and complete the corresponding triggering operation. In response to the user's triggering operation on the first capturing interface, the terminal device may acquire the first virtual resource and display the icon corresponding to the first virtual resource on the first capturing interface.

It should be understood that the embodiments of the present disclosure do not impose restrictions on the triggering operation on the first capturing interface. In some embodiments, in response to the capturing completion instruction triggered by the user, the terminal device may acquire the first virtual resource, i.e., obtain the first virtual resource after completing image capturing. In some other embodiments, in response to the image uploading-and-posting instruction triggered by the user, the terminal device acquires the first virtual resource when the first virtual resource is detected to be transferred to the user, i.e., obtains the first virtual resource after posting the image.

It should be noted that the terminal device may obtain the first virtual resource only after receiving the capturing completion instruction or the image uploading-and-posting instruction, or the terminal device may also obtain the first virtual resource after receiving the capturing completion instruction and the image uploading-and-posting instruction. The embodiments of the present disclosure are not limited in this aspect.

In the following, how to generate the triggering operation on the first capturing interface regarding the different target capturing modes involved in the embodiments of the present disclosure is described.

In some embodiments, the target capturing mode includes the first capturing mode, and the first capturing mode is configured to add the virtual object to the captured image. Accordingly, the triggering operation includes triggering the capturing completion instruction or the image uploading-and-posting instruction in the first capturing mode for the image to which the virtual object is added.

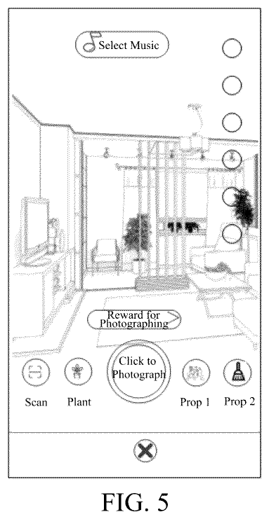

Exemplarily, FIG. 5 is a schematic diagram of a first capturing mode provided by an embodiment of the present disclosure. As shown in FIG. 5, after the user switches to the first capturing mode on the first capturing interface, other target capturing modes to be switched are displayed on the left side of the selected first capturing mode button on the first capturing interface, and the prop button is displayed on the right side of the first capturing mode button. By clicking on the virtual object (e.g., different types of props), the virtual object is added to the capturing background in the captured image.

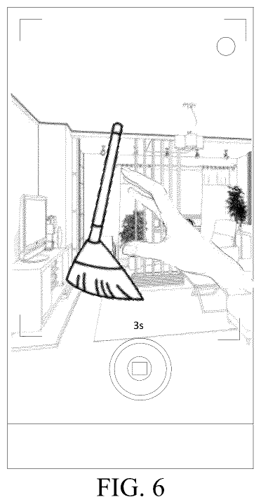

FIG. 6 is a schematic diagram of another first capturing mode provided by an embodiment of the present disclosure. As shown in FIG. 6, when the user clicks on the virtual object, the first capturing interface may be adjusted from the interface as illustrated in FIG. 5 to the interface as illustrated in FIG. 6, a to-be-captured image that is a combination of the virtual object and the capturing background is displayed, and the user may complete the capturing of the to-be-captured image by clicking on the capturing button.

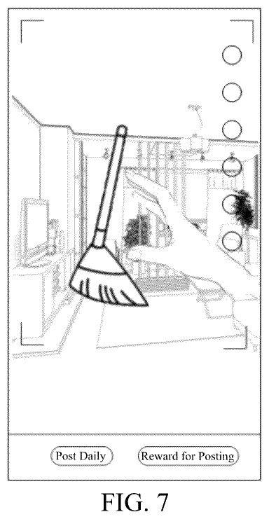

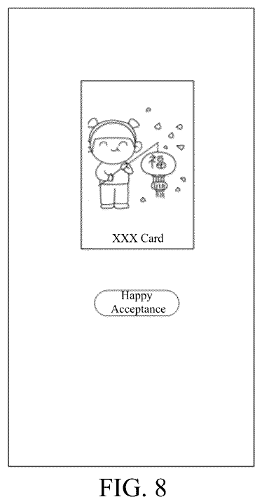

FIG. 7 is a schematic diagram of an image capturing completion interface provided by an embodiment of the present disclosure, and FIG. 8 is a schematic diagram of a virtual resource acquisition interface provided by an embodiment of the present disclosure. When the user completes the capturing of the to-be-captured image by combining the virtual object and the capturing background, the terminal device may directly switch to display the virtual resource acquiring interface as illustrated in FIG. 8 to display the virtual resource acquired by the user. Alternatively, after the user completes the capturing of the to-be-captured image by combining the virtual object and the capturing background, the terminal device may switch to display the image capturing completion interface as illustrated in FIG. 7. The user selects the posting control in FIG. 7, and after uploading and posting of the image is completed, the terminal device may switch to display the virtual resource acquisition interface as illustrated in FIG. 8, and display the virtual resource acquired by the user.

In some embodiments, the target capturing mode includes the second capturing mode, and the second capturing mode is configured to capture images. Accordingly, the triggering operation may be triggered in the second capturing mode to trigger the capturing completion instruction or the image uploading-and-posting instruction.

In some embodiments, the target capturing mode includes the third capturing mode, the third capturing mode is configured to identify the captured object to be identified, and the object to be identified includes a preset type of object or information code. Accordingly, when the object to be identified is an object of a preset type, the triggering operation includes the identification operation triggered in the third capturing mode on the object of the preset type displayed on the first capturing interface. When the object to be identified is the information code and the information code includes a user identification, the triggering operation includes identifying and/or adding the user identified by the information code.

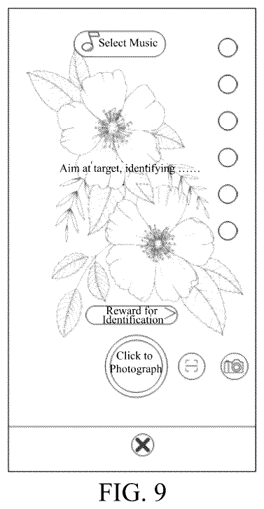

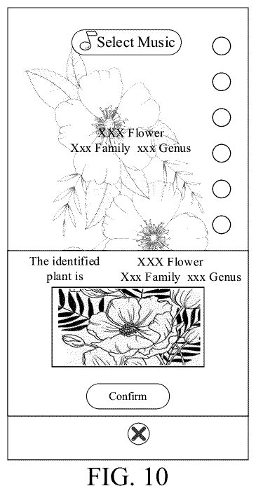

Exemplarily, FIG. 9 is a schematic diagram of a third capturing mode provided by an embodiment of the present disclosure, and FIG. 10 is a schematic diagram of another third capturing mode provided by an embodiment of the present disclosure. As shown in FIG. 9, the object to be identified in the third capturing mode is the plant, and accordingly, when the user identifies the plant in the third capturing mode, in response to the identification operation triggered on the plant, the terminal device may identify the species of the plant. Subsequently, as shown in FIG. 10, the terminal device displays a preset image of the identified species of the plant on the first capturing interface to be confirmed by the user. When the user clicks on the confirmation button to complete this identification, the terminal device may obtain the virtual resource, and may switch the display of the interface as shown in FIG. 10 to the virtual resource acquisition interface as shown in FIG. 8 and display the virtual resource obtained by the user.

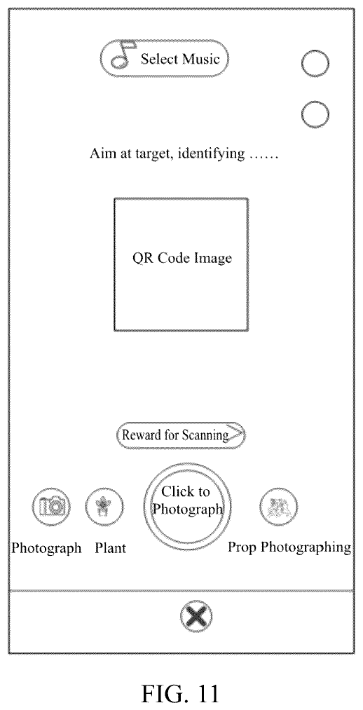

Exemplarily, FIG. 11 is a schematic diagram of still another third capturing mode provided by an embodiment of the present disclosure. As shown in FIG. 11, the object to be identified in the third capturing mode is the QR code, and accordingly, when the user identifies the QR code in the third capturing mode, the user information in the QR code may be obtained. In some cases, after identifying the QR code, the terminal device may obtain the virtual resource, and may switch the display of the interface shown in FIG. 11 to the virtual resource acquisition interface as shown in FIG. 8 and display the virtual resource obtained by the user. When users add the user, the terminal device may obtain the virtual resource, and may switch the interface shown in FIG. 11 to display the virtual resource acquisition interface as shown in FIG. 8 and display the virtual resource obtained by the user.

The method of obtaining the virtual resource provided by embodiments of the present disclosure displays the first capturing interface by responding to the first instruction triggered by the user, and the first capturing interface includes a plurality of target capturing modes. Subsequently, in response to the triggering operation of the user on the first capturing interface, the first virtual resource is obtained, and the icon corresponding to the first virtual resource is displayed on the first capturing interface. Here the target capturing modes include at least one variable capturing mode, and the variable capturing mode is configured to change with time. By this method, the first virtual resource can be obtained using a plurality of target capturing modes, and the target capturing modes may also vary with time, thereby increasing the functionality and flexibility of the camera, enriching the form of interaction with the user and other applications, and enabling the camera to have a relatively simple way of interaction invocation, thus expanding the provided functionality and interactivity without raising the difficulty of operation.

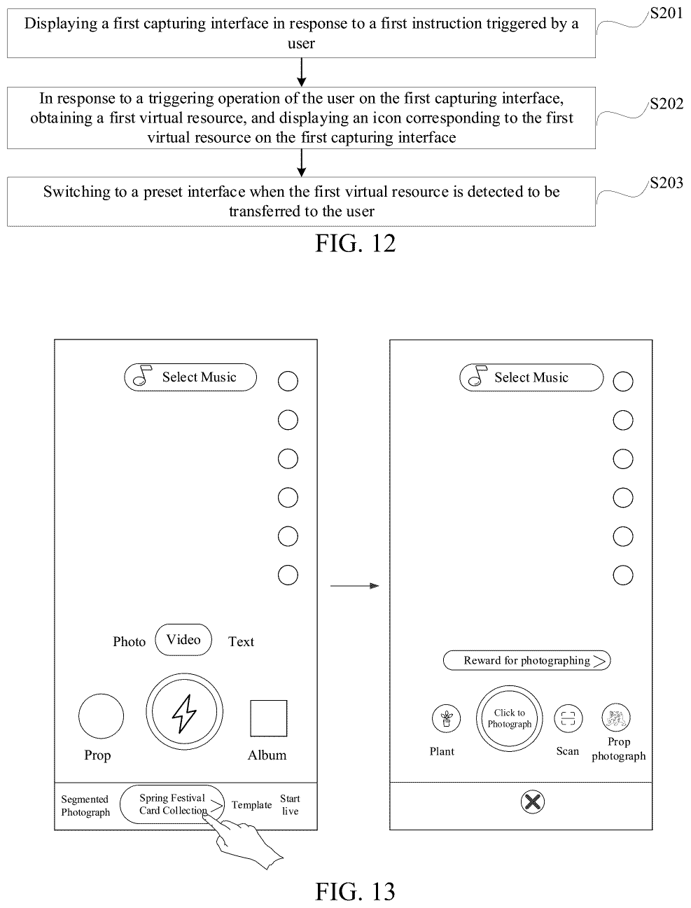

On the basis of the above embodiments, switching between various interfaces of the terminal device is described below. FIG. 12 is a flowchart of another method of obtaining a virtual resource provided by an embodiment of the present disclosure. As shown in FIG. 12, the method of obtaining the virtual resource provided by the present embodiment includes:

Step 201: displaying a first capturing interface in response to a first instruction triggered by a user, the first capturing interface including a plurality of target capturing modes.

Step 202: in response to a triggering operation of the user on the first capturing interface, obtaining a first virtual resource, and displaying an icon corresponding to the first virtual resource on the first capturing interface.

Here a plurality of the target capturing modes include at least one variable capturing mode, and the variable capturing mode is configured to change with time.

The technical terms, technical effects, technical features, and optional implementations of S201 to S202 may be understood with reference to S101 to S102 shown in FIG. 1. The repetitive contents are not repeated here.

Step 203: switching to a preset interface when the first virtual resource is detected to be transferred to the user, the preset interface including a control for triggering display of the first capturing interface.

Here the preset interface may be any type of interface, such as the video playing interface, the virtual resource display interface, the information interface of the user, etc. The control for triggering the display of the first capturing interface may be set at any position of the preset interface, such as on the activity icon for collecting the virtual resource.

In some embodiments, after detecting that the first virtual resource is transferred to the user, the terminal device completes the acquisition of the virtual resource. At this time, it may be switched to the preset interface according to the preset switching way. When the activity icon for collecting the virtual resource is still present on the preset interface, the user may cause the terminal device to switch to the first capturing interface again by clicking on the activity icon, so as to re-acquire the virtual resource.

Exemplarily, FIG. 13 is a schematic diagram of an interface switching provided by an embodiment of the present disclosure. After the first virtual resource is transferred to the user, the terminal device switches to the second capturing interface, that is, the preset interface is the second capturing interface. Subsequently, the user may switch the second capturing interface to the first capturing interface by clicking on the second control corresponding to the activity icon for collecting the virtual resource on the second capturing interface, and the virtual resource may be collected through various target capturing modes on the first capturing interface. The terminal device may switch to the video playing interface when it is detected that the captured image is successfully posted and the collection of the virtual resource is completed.

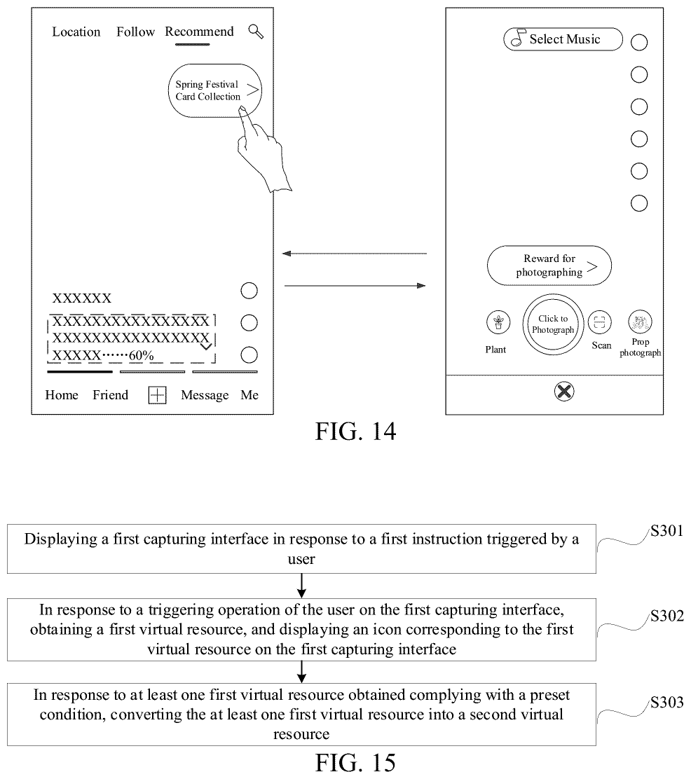

FIG. 14 is a schematic diagram of another interface switching provided by an embodiment of the present disclosure. As shown in FIG. 14, after the first virtual resource is transferred to the user, the terminal device switches to the video playing interface, that is, the preset interface is the video playing interface. The video playing interface is further provided with the fourth control corresponding to the activity icon for collecting virtual resources. By clicking on the fourth control, the terminal device may directly switch to the first capturing interface from the video playing interface, and virtual resources may be collected through various target capturing modes on the first capturing interface. After detecting that the captured image is successfully posted and the collection of virtual resources is completed, the terminal device may switch to the video playing interface again, and when there are still virtual resources to be collected, the fourth control may still exist on the video playing interface, and the first capturing interface may be accessed again by clicking on the fourth control, thereby achieving the cyclic collection of virtual resources.

On the basis of the above embodiments, how to switch between virtual resources is described below. FIG. 15 is a flowchart of still another method of obtaining a virtual resource provided by an embodiment of the present disclosure. As shown in FIG. 15, the method of obtaining the virtual resource provided by the present embodiment includes:

Step 301: displaying a first capturing interface in response to a first instruction triggered by a user, the first capturing interface including a plurality of target capturing modes.

Step 302: in response to a triggering operation of the user on the first capturing interface, obtaining a first virtual resource, and displaying an icon corresponding to the first virtual resource on the first capturing interface.

Here a plurality of the target capturing modes include at least one variable capturing mode, and the variable capturing mode is configured to change with time.

The technical terms, technical effects, technical features, and optional implementations of S301 to S302 may be understood with reference to S101 to S102 shown in FIG. 1. The repetitive contents are not repeated here.

Step S303: in response to at least one first virtual resource obtained complying with a preset condition, converting the at least one first virtual resource into a second virtual resource.

Here the preset condition may include the at least one first virtual resource obtained being duplicated with the obtained virtual resource, or the preset condition may be that the at least one first virtual resource satisfies a synthesis condition for the second virtual resource.

It should be understood that the first virtual resource and the second virtual resource are two resources with different states. The two resources with different states may be understood as the first virtual resource and the second virtual resource being different resources of the same type, e.g., a card A in an inactive state and a card B in an activated state. Alternatively, it may also be understood that the first virtual resource and the second virtual resource are different types of resources, e.g., a “gold card A1” and a “diamond card B,” or a “gold card A1” and a gold coin packet.

Exemplarily, in the case that the card A is obtained, while the virtual resources that the user has obtained include the card A, the card A may be converted to the card B that the user has not obtained.

Exemplarily, in the case that the “gold card A1,” the “gold card A2,” and the “gold card A3” are obtained, when the “gold card A1,” the “gold card A2,” and the “gold card A3” comply with the synthesis condition for a “diamond card B,” the “gold card A1,” the “gold card A2,” and the “gold card A3” may be merged into the “diamond card B.”

Exemplarily, in the case that the “gold card A1,” the “gold card A2,” and the “gold card A3” are obtained, when the “gold card A1,” the “gold card A2,” and the “gold card A3” comply with the synthesis condition for a gold coin packet, the “gold card A1,” the “gold card A2,” and the “gold card A3” may be merged into the gold coin packet, so as to wait for the user to click and open the gold coin packet at the specific time to obtain the gold coins.

The method of obtaining the virtual resource provided by embodiments of the present disclosure displays the first capturing interface by responding to the first instruction triggered by the user, and the first capturing interface includes a plurality of target capturing modes. Subsequently, in response to the triggering operation of the user on the first capturing interface, the first virtual resource is obtained, and the icon corresponding to the first virtual resource is displayed on the first capturing interface. Here the target capturing modes include at least one variable capturing mode, and the variable capturing mode is configured to change with time. By this method, the first virtual resource can be obtained using a plurality of target capturing modes, and the target capturing modes may also vary with time, thereby increasing the functionality and flexibility of the camera, enriching the form of interaction with the user and other applications, and enabling the camera to have a relatively simple way of interaction invocation, thus expanding the provided functionality and interactivity without raising the difficulty of operation.

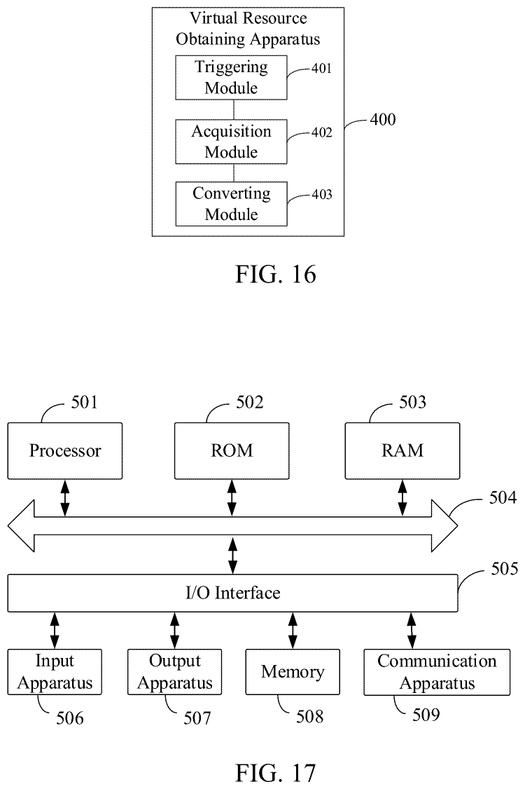

FIG. 16 is a schematic structural diagram of a virtual resource obtaining apparatus provided by an embodiment of the present disclosure. As illustrated in FIG. 16, the virtual resource obtaining apparatus 400 provided by the present embodiment includes:

a triggering module 401, configured to display a first capturing interface in response to a first instruction triggered by a user, where the first capturing interface includes a plurality of target capturing modes; and

an acquisition module 402, configured to, in response to a triggering operation of the user on the first capturing interface, obtain a first virtual resource, and display an icon corresponding to the first virtual resource on the first capturing interface, where the plurality of the target capturing modes include at least one variable capturing mode, and the variable capturing mode is configured to change with time.

According to one or more embodiments of the present disclosure, the acquisition module 402 is specifically configured to, in response to a capturing completion instruction triggered by the user, obtain the first virtual resource; and/or in response to an image uploading-and-posting instruction triggered by the user, obtain the first virtual resource when the first virtual resource is detected to be transferred to the user.

According to one or more embodiments of the present disclosure, the triggering module 401 is further configured to switch to a preset interface when the first virtual resource is detected to be transferred to the user, and the preset interface comprises a control for triggering display of the first capturing interface.

According to one or more embodiments of the present disclosure, the device 400 further includes:

a converting module 403, configured to, in response to at least one first virtual resource obtained complying with a preset condition, convert the at least one first virtual resource into a second virtual resource, where a state of the first virtual resource is different from a state of the second virtual resource.

According to one or more embodiments of the present disclosure, the converting module 403 is further configured to switch between different target capturing modes on the first capturing interface in response to a second instruction triggered by the user.

According to one or more embodiments of the present disclosure, a triggering method for the second instruction comprises sliding in a preset direction on the first capturing interface.

According to one or more embodiments of the present disclosure, the target capturing modes comprise a first capturing mode, and the first capturing mode is configured to add a virtual object to a captured image.

According to one or more embodiments of the present disclosure, the triggering operation comprises triggering, in the first capturing mode, the capturing completion instruction or the image uploading-and-posting instruction for an image to which the virtual object is added.

According to one or more embodiments of the present disclosure, the acquisition module 402 is further configured to: obtain a preset number of virtual objects from a virtual object pool according to a virtual object arranging order in case switching to the first capturing mode; and display at least one virtual object among the preset number of the virtual objects in a first target region on the first capturing interface.

According to one or more embodiments of the present disclosure, the virtual object arranging order is determined based on correlation information of the virtual object, and the correlation information of the virtual object comprises historical usage information of the virtual object and/or historical usage information of the user.

According to one or more embodiments of the present disclosure, the first capturing mode is the variable capturing mode, and the virtual object is updated according to a preset time period.

According to one or more embodiments of the present disclosure, the capturing modes comprise a second capturing mode, and the second capturing mode is configured to take a picture.

According to one or more embodiments of the present disclosure, the triggering operation comprises triggering the capturing completion instruction or the image uploading-and-posting instruction in the second capturing mode.

According to one or more embodiments of the present disclosure, the target capturing modes comprise a third capturing mode, and the third capturing mode is configured to identify a captured object to be identified.

According to one or more embodiments of the present disclosure, the object to be identified comprises a preset type of object or an information code.

According to one or more embodiments of the present disclosure, the triggering operation comprises an operation for identifying the preset type of object displayed on the first capturing interface in the third capturing mode.

According to one or more embodiments of the present disclosure, the triggering module 401 is further configured to identify the preset type of object in response to a triggered identifying operation for the preset type of object, and display a preset image corresponding to the preset type of object on the first capturing interface.

According to one or more embodiments of the present disclosure, the triggering operation comprises identifying and/or adding a user identified by the information code.

According to one or more embodiments of the present disclosure, the triggering module 401 is specifically configured to: switch a video playing interface to a second capturing interface in response to a third instruction triggered by the user, where the second capturing interface is provided with a first control corresponding to the first instruction; and switch the second capturing interface to the first capturing interface for display in response to the first instruction triggered by the user by clicking on the first control.

According to one or more embodiments of the present disclosure, the triggering module 401 is further configured to hide the first control in response to a fourth instruction triggered by the user by sliding a second target region of the second capturing interface.

According to one or more embodiments of the present disclosure, the triggering module 401 is specifically configured to switch a virtual resource display interface to the first capturing interface for display in response to the first instruction triggered by the user by clicking on a second control on the virtual resource display interface.

According to one or more embodiments of the present disclosure, the second control is configured to be respectively corresponding to different target capturing modes, and the triggering module 401 is further configured to switch the target capturing mode on the first capturing interface to a target capturing mode corresponding to the second control for triggering the first instruction.

According to one or more embodiments of the present disclosure, the triggering module 401 is specifically configured to switch a user information interface to the first capturing interface for display in response to the first instruction triggered by the user by clicking on a third control on the user information interface.

It should be noted that the virtual resource obtaining apparatus provided by the embodiment shown in FIG. 16 can be configured to perform the method provided by any one of the above embodiments, and the specific implementations and technical effects are similar and not repeated here.

FIG. 17 is a schematic structural diagram of an electronic device provided by an embodiment of the present disclosure. As shown in FIG. 17, it illustrates a schematic structural diagram of an electronic device 500 suitable for implementing the embodiments of the present disclosure. The terminal device in the embodiments of the present disclosure may include but not be limited to mobile terminals with image acquisition functions, such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device, etc., and fixed terminals (for example, externally connected to image acquisition devices), such as a digital TV, a desktop computer, a smart home device, etc. The electronic device shown in FIG. 17 is merely an example and will not impose any limitations on the function and the range of use of the embodiments of the present disclosure.

As illustrated in FIG. 17, the electronic device 500 may include a processor 501 (e.g., a central processing unit, a graphics processing unit, etc.), which may execute various appropriate actions and processing according to a program stored on a read-only memory (ROM) 502 or a program loaded from a memory 508 into a random access memory (RAM) 503. The random access memory (RAM) 503 further stores various programs and data required for operation of the electronic device 500. The processor 501, the ROM 502, and the RAM 503 are connected with each other through a bus 504. An input/output (I/O) interface 505 is also connected to the bus 504. The memory is configured to store programs for executing the methods of the various method embodiments described above, and the processor is configured to execute the programs stored in the memory, so as to implement the functions of the embodiments of the present disclosure as described above and/or other desired functions.

Usually, apparatuses below may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a speaker, a vibrator, or the like; a memory 508 including, for example, a magnetic tape, a hard disk, or the like; and a communication apparatus 509. The communication apparatus 509 may allow the electronic device 500 to perform wireless or wired communication with other devices so as to exchange data. Although FIG. 17 shows the electronic device 500 having various apparatuses, it should be understood that, it is not required to implement or have all the apparatuses illustrated, and the electronic device may alternatively implement or have more or fewer apparatuses.

Specifically, according to the embodiments of the present disclosure, the process described above with reference to the flowchart may be implemented as computer software programs. For example, the embodiments of the present disclosure include a computer program product, including a computer program carried on a non-transitory computer-readable medium, and the computer program includes program codes for executing the method shown in the flowchart of the embodiments of the present disclosure. In such embodiments, the computer program may be downloaded and installed from the network via the communication apparatus 509, or installed from the memory 508, or installed from the ROM 502. When executed by the processor 501, the computer program may implement the above functions defined in the method provided by the embodiments of the present disclosure.

It should be noted that, in the context of the present disclosure, the computer-readable medium may be a computer-readable signal medium or a computer-readable storage medium, or any combination thereof. For example, the computer-readable storage medium may be, but not limited to, an electric, magnetic, optical, electromagnetic, infrared, or semiconductor system, apparatus or device, or any combination thereof. Specific examples of the computer-readable storage medium may include, but not limited to, an electrical connection with one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including, but not limited to, an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program codes contained on the computer-readable medium may be transmitted by using any suitable medium, including, but not limited to, an electric wire, a fiber-optic cable, radio frequency (RF) and the like, or any appropriate combination of them.

The above-described computer-readable medium may be included in the above-described electronic device, or may also exist alone without being assembled into the electronic device.

The above-mentioned computer-readable medium carries one or more programs, and the one or more programs, when executed by the electronic device, cause the electronic device to: display a first capturing interface in response to a first instruction triggered by a user, where the first capturing interface comprises a plurality of target capturing modes; and in response to a triggering operation of the user on the first capturing interface, obtain a first virtual resource, and display an icon corresponding to the first virtual resource on the first capturing interface, where the plurality of the target capturing modes comprise at least one variable capturing mode, and the variable capturing mode is configured to change with time.

The computer program codes for performing the operations of the present disclosure may be written in one or more programming languages or a combination thereof. The above-described programming languages include but are not limited to object-oriented programming languages, such as Java, Smalltalk, C++, and also include conventional procedural programming languages, such as the “C” programming language or similar programming languages. The program codes may by executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

In some implementations, the client terminal and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The flow chart and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules involved in the embodiments of the present disclosure may be implemented in software or hardware. Here the name of the module does not constitute a limitation of the unit itself under certain circumstances.

The functions described herein above may be performed, at least partially, by one or more hardware logic components. For example, available exemplary types of hardware logic components include: a field programmable gate array (FPGA), an application specific integrated circuit (ASIC), application specific standard parts (ASSP), a system on chip (SOC), a complex programmable logical device (CPLD), etc.

In the context of the present disclosure, the computer-readable medium may be a tangible medium containing or storing a program that can be used by or in combination with an instruction execution system, apparatus or device. The computer-readable medium may be a computer-readable signal medium or a computer-readable storage medium. The computer-readable medium may include, but not limited to, an electric, magnetic, optical, electromagnetic, infrared, or semiconductor system, apparatus or device, or any appropriate combination thereof. Specific examples of the computer-readable storage medium may include: an electrical connection based on one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them.

In the first aspect, according to one or more embodiments of the present disclosure, a method of obtaining a virtual resource is provided and comprises:

displaying a first capturing interface in response to a first instruction triggered by a user, wherein the first capturing interface comprises a plurality of target capturing modes; and

in response to a triggering operation of the user on the first capturing interface, obtaining a first virtual resource, and displaying an icon corresponding to the first virtual resource on the first capturing interface,

wherein the plurality of the target capturing modes comprise at least one variable capturing mode, and the variable capturing mode is configured to change with time.

According to one or more embodiments of the present disclosure, in response to the triggering operation of the user on the first capturing interface, obtaining the first virtual resource comprises:

in response to a capturing completion instruction triggered by the user, obtaining the first virtual resource; and/or

in response to an image uploading-and-posting instruction triggered by the user, obtaining the first virtual resource when the first virtual resource is detected to be transferred to the user.

According to one or more embodiments of the present disclosure, the method further comprises:

switching to a preset interface when the first virtual resource is detected to be transferred to the user, wherein the preset interface comprises a control for triggering display of the first capturing interface.

According to one or more embodiments of the present disclosure, after obtaining the first virtual resource, and displaying the icon corresponding to the first virtual resource on the first capturing interface, the method further comprises:

in response to at least one first virtual resource obtained complying with a preset condition, converting the at least one first virtual resource into a second virtual resource, wherein a state of the first virtual resource is different from a state of the second virtual resource.

According to one or more embodiments of the present disclosure, after displaying the first capturing interface in response to the first instruction triggered by the user, the method further comprises:

switching between different target capturing modes on the first capturing interface in response to a second instruction triggered by the user.

According to one or more embodiments of the present disclosure, a triggering method for the second instruction comprises sliding in a preset direction on the first capturing interface.

According to one or more embodiments of the present disclosure, the target capturing modes comprise a first capturing mode, and the first capturing mode is configured to add a virtual object to a captured image.

According to one or more embodiments of the present disclosure, the triggering operation comprises triggering, in the first capturing mode, the capturing completion instruction or the image uploading-and-posting instruction for an image to which the virtual object is added.

According to one or more embodiments of the present disclosure, after switching between different target capturing modes on the first capturing interface, the method further comprises:

obtaining a preset number of virtual objects from a virtual object pool according to a virtual object arranging order in case switching to the first capturing mode; and

displaying at least one virtual object among the preset number of the virtual objects in a first target region on the first capturing interface.

According to one or more embodiments of the present disclosure, the virtual object arranging order is determined based on correlation information of the virtual object, and the correlation information of the virtual object comprises historical usage information of the virtual object and/or historical usage information of the user.

According to one or more embodiments of the present disclosure, the first capturing mode is the variable capturing mode, and the virtual object is updated according to a preset time period.

According to one or more embodiments of the present disclosure, the capturing modes comprise a second capturing mode, and the second capturing mode is configured to take a picture.

According to one or more embodiments of the present disclosure, the triggering operation comprises triggering the capturing completion instruction or the image uploading-and-posting instruction in the second capturing mode.

According to one or more embodiments of the present disclosure, the target capturing modes comprise a third capturing mode, and the third capturing mode is configured to identify a captured object to be identified.

According to one or more embodiments of the present disclosure, the object to be identified comprises a preset type of object or an information code.

According to one or more embodiments of the present disclosure, the triggering operation comprises an operation for identifying the preset type of object displayed on the first capturing interface in the third capturing mode.

According to one or more embodiments of the present disclosure, after displaying the first capturing interface, the method further comprises:

identifying the preset type of object in response to a triggered identifying operation for the preset type of object; and

displaying a preset image corresponding to the preset type of object on the first capturing interface.

According to one or more embodiments of the present disclosure, the triggering operation comprises identifying and/or adding a user identified by the information code.

According to one or more embodiments of the present disclosure, before displaying the first capturing interface in response to the first instruction triggered by the user, the method further comprises:

switching a video playing interface to a second capturing interface in response to a third instruction triggered by the user, wherein the second capturing interface is provided with a first control corresponding to the first instruction,

wherein displaying the first capturing interface in response to the first instruction triggered by the user comprises:

switching the second capturing interface to the first capturing interface for display in response to the first instruction triggered by the user by clicking on the first control.

According to one or more embodiments of the present disclosure, after switching the video playing interface to the second capturing interface, the method further comprises:

hiding the first control in response to a fourth instruction triggered by the user by sliding a second target region of the second capturing interface.

According to one or more embodiments of the present disclosure, displaying the first capturing interface in response to the first instruction triggered by the user comprises:

switching a virtual resource display interface to the first capturing interface for display in response to the first instruction triggered by the user by clicking on a second control on the virtual resource display interface.

According to one or more embodiments of the present disclosure, the second control is configured to be a plurality of second controls respectively corresponding to different target capturing modes, and after switching the virtual resource display interface to the first capturing interface for display, the method further comprises:

switching the target capturing mode on the first capturing interface to a target capturing mode corresponding to the second control for triggering the first instruction.

According to one or more embodiments of the present disclosure, displaying the first capturing interface in response to the first instruction triggered by the user comprises:

switching a user information interface to the first capturing interface for display in response to the first instruction triggered by the user by clicking on a third control on the user information interface.

In the second aspect, according to one or more embodiments of the present disclosure, a virtual resource obtaining apparatus is provided and comprises:

a triggering module, configured to display a first capturing interface in response to a first instruction triggered by a user, wherein the first capturing interface comprises a plurality of target capturing modes; and

an acquisition module, configured to, in response to a triggering operation of the user on the first capturing interface, obtain a first virtual resource, and display an icon corresponding to the first virtual resource on the first capturing interface, wherein the plurality of the target capturing modes comprise at least one variable capturing mode, and the variable capturing mode is configured to change with time.

According to one or more embodiments of the present disclosure, the acquisition module is specifically configured to, in response to a capturing completion instruction triggered by the user, obtain the first virtual resource; and/or in response to an image uploading-and-posting instruction triggered by the user, obtain the first virtual resource when the first virtual resource is detected to be transferred to the user.

According to one or more embodiments of the present disclosure, the triggering module is further configured to switch to a preset interface when the first virtual resource is detected to be transferred to the user, and the preset interface comprises a control for triggering display of the first capturing interface.

According to one or more embodiments of the present disclosure, the device further includes:

a converting module, configured to, in response to at least one first virtual resource obtained complying with a preset condition, convert the at least one first virtual resource into a second virtual resource, where a state of the first virtual resource is different from a state of the second virtual resource.

According to one or more embodiments of the present disclosure, the converting module is further configured to switch between different target capturing modes on the first capturing interface in response to a second instruction triggered by the user.

According to one or more embodiments of the present disclosure, a triggering method for the second instruction comprises sliding in a preset direction on the first capturing interface.

According to one or more embodiments of the present disclosure, the target capturing modes comprise a first capturing mode, and the first capturing mode is configured to add a virtual object to a captured image.

According to one or more embodiments of the present disclosure, the triggering operation comprises triggering, in the first capturing mode, the capturing completion instruction or the image uploading-and-posting instruction for an image to which the virtual object is added.

According to one or more embodiments of the present disclosure, the acquisition module is further configured to: obtain a preset number of virtual objects from a virtual object pool according to a virtual object arranging order in case switching to the first capturing mode; and display at least one virtual object among the preset number of the virtual objects in a first target region on the first capturing interface.

According to one or more embodiments of the present disclosure, the virtual object arranging order is determined based on correlation information of the virtual object, and the correlation information of the virtual object comprises historical usage information of the virtual object and/or historical usage information of the user.

According to one or more embodiments of the present disclosure, the first capturing mode is the variable capturing mode, and the virtual object is updated according to a preset time period.

According to one or more embodiments of the present disclosure, the capturing modes comprise a second capturing mode, and the second capturing mode is configured to take a picture.

According to one or more embodiments of the present disclosure, the triggering operation comprises triggering the capturing completion instruction or the image uploading-and-posting instruction in the second capturing mode.

According to one or more embodiments of the present disclosure, the target capturing modes comprise a third capturing mode, and the third capturing mode is configured to identify a captured object to be identified.

According to one or more embodiments of the present disclosure, the object to be identified comprises a preset type of object or an information code.

According to one or more embodiments of the present disclosure, the triggering operation comprises an operation for identifying the preset type of object displayed on the first capturing interface in the third capturing mode.

According to one or more embodiments of the present disclosure, the triggering module is further configured to identify the preset type of object in response to a triggered identifying operation for the preset type of object, and display a preset image corresponding to the preset type of object on the first capturing interface.

According to one or more embodiments of the present disclosure, the triggering operation comprises identifying and/or adding a user identified by the information code.

According to one or more embodiments of the present disclosure, the triggering module is specifically configured to: switch a video playing interface to a second capturing interface in response to a third instruction triggered by the user, where the second capturing interface is provided with a first control corresponding to the first instruction; and switch the second capturing interface to the first capturing interface for display in response to the first instruction triggered by the user by clicking on the first control.

According to one or more embodiments of the present disclosure, the triggering module is further configured to hide the first control in response to a fourth instruction triggered by the user by sliding a second target region of the second capturing interface.

According to one or more embodiments of the present disclosure, the triggering module is specifically configured to switch a virtual resource display interface to the first capturing interface for display in response to the first instruction triggered by the user by clicking on a second control on the virtual resource display interface.

According to one or more embodiments of the present disclosure, the second control is configured to be respectively corresponding to different target capturing modes, and the triggering module is further configured to switch the target capturing mode on the first capturing interface to a target capturing mode corresponding to the second control for triggering the first instruction.

According to one or more embodiments of the present disclosure, the triggering module is specifically configured to switch a user information interface to the first capturing interface for display in response to the first instruction triggered by the user by clicking on a third control on the user information interface.

In the third aspect, the embodiments of the present disclosure further provide an electronic device, comprising:

a processor; and

a memory, configured to store a computer program,

where the processor is configured to implement the method of obtaining the virtual resource according to the first aspect and various possible designs of the first aspect described above by executing the computer program.

In the fourth aspect, the embodiments of the present disclosure further provide a computer-readable storage medium, the computer-readable storage medium stores computer-executable instructions, and the computer-executable instructions, when executed by a processor, cause the processor to implement the method of obtaining the virtual resource according to the first aspect and various possible designs of the first aspect described above.

In the fifth aspect, the embodiments of the present disclosure further provide a computer program product, the computer program product comprises a computer program, and the computer program, when executed by a processor, causes the processor to implement the method of obtaining the virtual resource according to the first aspect and various possible designs of the first aspect described above.

In the sixth aspect, the embodiments of the present disclosure further provide a computer program, and the computer program, when executed by a processor, causes the processor to implement the method of obtaining the virtual resource according to the first aspect and various possible designs of the first aspect described above.

The foregoing are merely descriptions of the preferred embodiments of the present disclosure and the explanations of the technical principles involved. It should be understood by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the scope of the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method actions, it should be understood that the subject matter defined in the appended claims is not necessarily limited to the particular features and actions described above. Rather, the particular features and actions described above are merely exemplary forms for implementing the claims.

What is claimed is:

1. A method of obtaining a virtual resource, comprising:
displaying a first capturing interface in response to a first instruction triggered by a user, wherein the first capturing interface comprises a plurality of target capturing modes; and
in response to a triggering operation of the user on the first capturing interface, obtaining a first virtual resource, and displaying an icon corresponding to the first virtual resource on the first capturing interface,
wherein the plurality of the target capturing modes comprise at least one variable capturing mode.

2. The method according to claim 1, wherein in response to the triggering operation of the user on the first capturing interface, obtaining the first virtual resource comprises:
in response to a capturing completion instruction triggered by the user, obtaining the first virtual resource; and/or
in response to an image uploading-and-posting instruction triggered by the user, obtaining the first virtual resource when the first virtual resource is detected to be transferred to the user.

3. The method according to claim 2, wherein the method further comprises:
switching to a preset interface when the first virtual resource is detected to be transferred to the user, wherein the preset interface comprises a control for triggering display of the first capturing interface.

4. The method according to claim 1, wherein after obtaining the first virtual resource, and displaying the icon corresponding to the first virtual resource on the first capturing interface, the method further comprises:
in response to at least one first virtual resource obtained complying with a preset condition, converting the at least one first virtual resource into a second virtual resource, wherein a state of the first virtual resource is different from a state of the second virtual resource.

5. The method according to claim 1, wherein after displaying the first capturing interface in response to the first instruction triggered by the user, the method further comprises:
switching between different target capturing modes on the first capturing interface in response to a second instruction triggered by the user.

6. The method according to claim 5, wherein a triggering method for the second instruction comprises sliding in a preset direction on the first capturing interface.

7. The method according to claim 5, wherein the target capturing modes comprise a first capturing mode, and the first capturing mode is configured to add a virtual object to a captured image.

8. The method according to claim 7, wherein the triggering operation comprises triggering, in the first capturing mode, the capturing completion instruction or the image uploading-and-posting instruction for an image to which the virtual object is added.

9. The method according to claim 7, wherein after switching between different target capturing modes on the first capturing interface, the method further comprises:
obtaining a preset number of virtual objects from a virtual object pool according to a virtual object arranging order in case switching to the first capturing mode; and
displaying at least one virtual object among the preset number of the virtual objects in a first target region on the first capturing interface.

10. (canceled)

11. The method according to claim 7, wherein the first capturing mode is the variable capturing mode, and the virtual object is updated according to a preset time period.

12. The method according to claim 5, wherein the target capturing modes comprise a second capturing mode, and the second capturing mode is configured to take a picture; and
the triggering operation comprises triggering the capturing completion instruction or the image uploading-and-posting instruction in the second capturing mode.

13. (canceled)

14. The method according to claim 5, wherein the target capturing modes comprise a third capturing mode, and the third capturing mode is configured to identify a captured object to be identified.

15. The method according to claim 14, wherein the object to be identified comprises a preset type of object or an information code.

16. The method according to claim 15, wherein the triggering operation comprises an operation for identifying the preset type of object displayed on the first capturing interface in the third capturing mode.

17. The method according to claim 15, wherein after displaying the first capturing interface, the method further comprises:
identifying the preset type of object in response to a triggered identifying operation for the preset type of object; and
displaying a preset image corresponding to the preset type of object on the first capturing interface.

18. The method according to claim 15, wherein the triggering operation comprises identifying and/or adding a user identified by the information code.

19. The method according to claim 1, wherein before displaying the first capturing interface in response to the first instruction triggered by the user, the method further comprises:
switching a video playing interface to a second capturing interface in response to a third instruction triggered by the user, wherein the second capturing interface is provided with a first control corresponding to the first instruction,
wherein displaying the first capturing interface in response to the first instruction triggered by the user comprises:
switching the second capturing interface to the first capturing interface for display in response to the first instruction triggered by the user by triggering the first control.

20. (canceled)

21. The method according to claim 1, wherein displaying the first capturing interface in response to the first instruction triggered by the user comprises:
switching a virtual resource display interface to the first capturing interface for display in response to the first instruction triggered by the user by clicking on a second control on the virtual resource display interface;
the second control is configured to be a plurality of second controls respectively corresponding to different target capturing modes; and
after switching the virtual resource display interface to the first capturing interface for display, the method further comprises:
switching the target capturing mode on the first capturing interface to a target capturing mode corresponding to the second control for triggering the first instruction.

22. (canceled)

23. The method according to claim 1, wherein displaying the first capturing interface in response to the first instruction triggered by the user comprises:
switching a user information interface to the first capturing interface for display in response to the first instruction triggered by the user by clicking on a third control on the user information interface.

24. A virtual resource obtaining apparatus, comprising:
a triggering module, configured to display a first capturing interface in response to a first instruction triggered by a user, wherein the first capturing interface comprises a plurality of target capturing modes; and
an acquisition module, configured to, in response to a triggering operation of the user on the first capturing interface, obtain a first virtual resource, and display an icon corresponding to the first virtual resource on the first capturing interface, wherein the plurality of the target capturing modes comprise at least one variable capturing mode.

25-28. (canceled)
